(19) United States
(12) Patent Application Publication
(10) Pub. No.: US 2014/0155641 A1
(43) Pub. Date: Jun. 5, 2014

(54) SELENIUM ATTACHMENT AGENT

(71) Applicant: Robert Eugene Hanes, Austin, TX (US)

(72) Inventor: Robert Eugene Hanes, Austin, TX (US)

(73) Assignee: SELENIUM, LTD., Austin, TX (US)

(21) Appl. No.: 13/704,899

(22) PCT Filed: Jun. 17, 2011
(86) PCT No.: PCT/US2011/040949

§ 371 Date: Feb. 13, 2014

Related U.S. Application Data
(60) Provisional application No. 61/355,942, filed on Jun. 17, 2010.

(51) Int. Cl. C09D 5/14

(52) U.S. Cl. CPC C09D 5/14
USPC 556/54; 556/437; 562/899

(57) ABSTRACT

The present invention comprises compositions and methods for a selenium attachment agent and uses thereof, wherein the selenium attachment agent facilitates the attachment of desired molecules to a surface. In particular, surfaces are enhanced to include antimicrobial or biocidal characteristics, including an organoselenium compound for biocidal properties.

### PRIORITY CLAIM

This application claims the benefit of the filing date of U.S. Provisional Patent Application No. 61/355,942 filed on Jun. 17, 2010, which is herein incorporated by reference in its entirety.

### TECHNICAL FIELD OF THE INVENTION

The present invention relates in general to the field of the attachment of compounds to substrates, more particularly to antimicrobial applications, and most particularly, to novel compositions and methods for making anti-microbial coatings containing organoselenium additives.

### STATEMENT REGARDING FEDERALLY SPONSORED RESEARCH OR DEVELOPMENT

Not Applicable.

### BACKGROUND OF THE INVENTION

For surfaces involving human and industrial use, including but not limited to, indwelling medical devices such as catheters and orthopedic devices are becoming essential to patient care. The benefit derived from these catheters, orthopedic devices, and other types of medical implants, however, is often offset by infectious complications.

Colonization of bacteria on surfaces, such as the surface of an implant or other parts of the device can produce serious patient problems, including the need to remove and/or replace the implanted device and to vigorously treat secondary infective conditions. A considerable amount of attention and study has been directed toward preventing such colonization by the use of antimicrobial agents, such as antibiotics, bound to the surface of the materials employed in such devices. In such attempts, the objective has been to produce a sufficient bacteriostatic or bactericidal action to prevent colonization.

Historically, an orthopedic fixation was applied to stabilize fractures and maintain the reduction of a deformity. For example, the earliest fixation methods involved the use of loops of silver wire, which were passed around the spinous process to immobilize the spine in cases of tuberculosis. Later, attempts were made to wire supporting rods made of synthetic material and/or iron to the spine to maintain stabilization. But, because these were ferrous materials, electrolytic reactions occurred, infections developed, and the results were generally unsatisfactory.

Over the years there has been an evolution to the use of different materials for stabilization, internal splintage and fixation. For example, by the 1930s Venable and Stuck, two orthopedists in Texas, identified that the use of an orthodontic alloy called Vitallium was very suitable in orthopedics. (See, Venable C. S., et al., Ann Surg. 105, 917-938 (1937), the disclosure of which is incorporated herein by reference.) The material was unreactive with the tissues and indeed this stainless steel alloy was the main material for internal fixation and stabilization for the next sixty years. However, because of changing imaging technologies, stainless steel alloys, which produced greater artifacts during the imaging process, have been replaced by other materials, such as titanium. In addition, stainless steel alloys add the complication of a fibrous scar, which encapsulated the device. Titanium, on the other hand, functions more like a ceramic material, in that bone actually grows into the interstices of the crystalline lattice structure of the material producing superior fixation.

Many implants today are coated in silver, which can be problematic. For instance, the St. Jude Medical Silzone heart valve had been reported to cause chronic inflammatory reaction due to a toxic reaction to silver, leading to the product being withdrawn from the market.

Another area of concern is infection caused by the introduction of the implant into the patient or the use of an implant in a clinical setting where increased rate of infection in immuno-suppressed patients is prevalent. The treatment of infected implants is quite controversial. There are those who feel that the removal of the implant is the only way to eradicate the infection. However, there are others who feel that the removal of the implant promotes instability, condition. For example, often it is found that the implant becomes problematic because bacteria hide in the interstices of the crystalline structure of the metal or nonmetal implant. This makes the eradication of infection difficult. On the other hand, the clinical challenge is that if the internal stabilizing system is removed, the deformity can recur and stability may be lost, which can effect neurological and vascular function and/or result in a great increase in the patient's pain and discomfort. Moreover, the incidence of chronic infection in the United States is increasing as more and more antibiotic resistant bacteria are spreading through hospitals, extended care facilities and the community.

As a result, all too often patients have delayed recovery because of infection, implants are removed, and patients are treated with the implant removed. Because of the enormous surgical and clinical complications that can arise from such drastic revision surgery, it is often the case that patients are faced with a less than perfect clinical outcome. It is thus a substantial need in the art to develop compositions and methods that will allow safe and effective treatments of substrates and devices to prevent many of the aforementioned limitations.

### SUMMARY OF THE INVENTION

The invention set forth above is described by the embodiments of the invention described herein below:

The present invention provides a method of binding a selenium attachment agent comprised of a functional end for the attachment to a surface. Said surface could potentially be titanium, or a wide variety of other materials that could be used in medical devices. The selenium attachment agent may further contain a selenium group which can be attached in a variety of methods explored below, the end result being a coating of selenium permanently bound to the surface material, resulting in a biofilm-rejecting solution that is superior to current antimicrobial coatings and compounds used in medical devices.

This particular aspect of the invention is based upon the finding that inorganic and organic selenium compounds, which catalyze the formation of free radical superoxide ions in the presence of both oxygen and a reducing agent such a reduced thiol group or other electron donor, have biocidal activity when brought into contact with a microbe, such as but not limited to, bacteria, viruses, mold, fungi, protozoan parasites, plant cells, animal cells, biological materials and combinations thereof. These properties make selenium an ideal addition to current medical devices, as its biocidal properties are superior to other options, such as silver, which has been known to cause silver toxicity and deteriorate over time.

Further, the selenium attachment agent can be combined with functional groups for the promotion or inhibition of the growth of tissues. The process of covalently attaching selenium to either an aliphatic or ether residue, which is then terminated with a variety of methods, resulting in the incorporation into a polymer formulation containing a protecting group which could consist of a variety of useful chemical agents, some of which could promote the growth of tissues, further increasing the successful rate at which medical devices are introduced to the body.

### BRIEF DESCRIPTION OF THE DRAWINGS

FIG. 1 of the accompanying drawings is the chemical structural formula illustrating a spacer possessing a rigid framework;

FIG. 2 of the accompanying drawings is the chemical structural formula illustrating a spacer;

FIG. 3 of the accompanying drawings is the chemical structural formula of a preparation of deselenide dimethacrylate;

FIG. 4 of the accompanying drawings is the chemical structural formula for the preparation of deselenide dialcohol as monomer in polymerization;

FIG. 5 of the accompanying drawings is the chemical structural formula of a general method for coating titanium with an anchor group;

FIG. 6 of the accompanying drawings is the chemical structural formula of a general method for coating titanium with an anchor group;

FIG. 7 of the accompanying drawings is the chemical structural formula of a selenium attachment agent comprising an anchor group;

FIG. 8 of the accompanying drawings is the chemical structural formula of a selenium attachment agent comprising an anchor group;

FIG. 9 of the accompanying drawings is the chemical structural formula of a general method for preparing diselenides using dilithium diselenide under organic conditions;

FIG. 10 of the accompanying drawings is the chemical structural formula of a general method for the attachment of trialkoxy silanes to activated surfaces or reactive additives;

FIG. 11 of the accompanying drawings is the chemical structural formula of a general method for impregnating a medical grade wound dressing with a medical grade polymer made antimicrobial from covalent attachment.

FIG. 12 of the accompanying drawings is the chemical structural formula of a preparation of deselenide tetralcohol as monomer in polymerization;

FIG. 13 the accompanying drawings is the chemical structural of an intermediate tetramesylate used in the preparation of the diselenide tetramine;

FIG. 14 of the accompanying drawings is the chemical structural formula of preparation of deseienide tetramine for conjugation to proteins, antibodies or enzymes;

FIG. 15 of the accompanying drawings is the chemical structural formula of an activated dicarboxylic diselenide for conjugation to proteins, antibodies or enzymes;

FIG. 16 of the accompanying drawings is the chemical structural formula of a monomer in polymerization of for conjugation to proteins, antibodies or enzymes;

FIG. 16 of the accompanying drawings is the chemical structural formula of a dimethacrylate for polymerization and is a preferred chemical entity of the present invention to a dimethacrylate;

FIG. 17 of the accompanying drawings is the chemical structural formula of a preferred chemical entity of the present invention prepared by an alternate method.

FIG. 18 of the accompanying drawings is the chemical structural formula of a preferred chemical entity of the present invention.

### DETAILED DESCRIPTION OF THE PREFERRED EMBODIMENT

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

Before explaining at least one embodiment of the invention in detail by way of exemplary drawings, experimentation, results, and laboratory procedures, it is to be understood that the invention is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used for recombinant DNA, oligonucleotide synthesis, and tissue culture and transformation (e.g., electroporation, lipofection). Enzymatic reactions and purification techniques are performed according to manufacturer's specifications or as commonly accomplished in the art or as described herein. The foregoing techniques and procedures are generally performed according to conventional methods well known in the art and as described in various general and more specific references that are cited and discussed throughout the present specification. See e.g., Sambrook et al. Molecular Cloning: A Laboratory Manual (2^{nd} ed., Cold Spring Harbor Laboratory Press, Cold Spring Harbor, N.Y. (1989) and Coligan et al. Current Protocols in Immunology (Current Protocols, Wiley Interscience (1994)), which are incorporated herein by reference. The nomenclatures utilized in connection with, and the laboratory procedures and techniques of, analytical chemistry, synthetic organic chemistry, and medicinal and pharmaceutical chemistry described herein are those well known and commonly used in the art. Standard techniques are used for chemical syntheses, chemical analyses, pharmaceutical preparation, formulation, and delivery, and treatment of patients.

As utilized in accordance with the present disclosure, the following terms, unless otherwise indicated, shall be understood to have the following meanings.

The terms “attached”, “covalently attached”, “covalent bonding” and “covalent attachment” as used herein will be understood to refer to a stable chemical link between two atoms produced by sharing of one or more pairs of electrons. Covalent bonding is an intramolecular form of chemical bonding characterized by the sharing of one or more pairs of electrons between two components, producing a mutual attraction that holds the resultant molecule together. Atoms tend to share electrons in such a way that their outer electron shells are filled. Such bonds are always stronger than the intermolecular hydrogen bond and similar in strength to or stronger than the ionic bond. In contrast to the ionic and metallic bond, the covalent bond is directional, i.e. the bond angles have a great impact on the strength of the bond. Because of the directional character of the bond, covalently bound materials are more difficult to deform than metals.

The term “biocide” as utilized herein refers to a chemical substance capable of killing different forms of living organisms. A biocide can be a pesticide, such as but not limited to, fungicides, herbicides, insecticides, algicides, moluscicides, miticides, and rodenticides; or the biocide can be an antimicrobial, such as but not limited to, germicides, antibiotics, antibacterials, antivirals, antifungals, antiprotozoans, and antiparasites.

The term “surface” may be any solid surface or substrate including metal, titanium, titanium alloys, tin-nickel alloys, shape memory alloys, aluminum oxide, platinum, platinum alloys, stainless steel, MP35N stainless steel, elgiloy, stellite, pyrolytic carbon, silver carbon, glassy carbon, polymer, polyamide, polycarbonate, polyether, polyester, polyolefin, polyethylene, polypropylene, polystyrene, polyurethane, polyvinyl chloride, polyvinylpyrrolidone, silicone elastomer, fluoropolymer, polyacrylate, polyisoprene, polytetrafluoroethylene, rubber, ceramic, hydroxapatite, human protein, human tissue, animal protein, animal tissue, bone, skin, teeth, collagen, laminin, elastin, fibrin, wood, cellulose, compressed carbon and glass. A surface may also apply to solid substrates such as films, particularly polymeric films such as polysilicones, polyolefins, polyamides, teflon, and many others too numerous to list.

The term “plastics” as utilized in accordance with the present invention refers to any of numerous substances that can be shaped and molded when subjected to heat or pressure. Plastics are easily shaped because they consist of long-chain molecules known as polymers, which do not break apart when flexed. Plastics are usually artificial resins but can also be natural substances, as in certain cellular derivatives and shellac. Plastics can be pressed into thin layers, formed into objects, or drawn into fibers for use in textiles. Most do not conduct electricity well, are low in density, and are often very tough. Polyvinyl chloride, methyl methacrylate, and polystyrene are plastics.

The term “microbe” as utilized in accordance with the present invention refers to any living cell(s), virus or organism that is killed or suppressed when exposed to free radicals. The term “microbe” includes, but is not limited to, prokaryotes such as bacteria and archebacteria; viruses; eukaryotes such as mold, fungi, protozoans parasites, plant cells and animal cells; and biological materials such as proteins, carbohydrates, lipids and nucleotides. Examples of prokaryotes include, but are not limited to, bacteria such as for example, Staphylococcus aureus, Pseudomonas, Escherichia coli, and Bacillus subtilis. Examples of viruses include, but are not limited to, Poxvirus, Papillomavirus, Filovirus, Bornavirus, Mimivirus, Picornavirus, Adenovirus, Retrovirus, Paramyxovirus, Flavivirus, Parvovirus, Hepadnavirus, Calcivirus, and Orthomyxovirus and Bacteriophage; specific viral examples include HIV, Rhinovirus, West Nile, Influenza, smallpox, and herpes simplex. Examples of parasites include, but are not limited to, arthropod parasites, helminth parasites, protozoal parasites, and hematoprotozoal parasites; specific examples include demodex mange, hookworm, and coccidia. Examples of eukaryotic cells include, but are not limited to, fibroblast cells, barnacles, epithelial cells, and cancer cells, including but not limited to, prostate cancer cells, breast cancer cells, leukemia, and lymphoma.

The term “agent” is used herein to denote a chemical compound, a mixture of chemical compounds, a biological macromolecule, or an extract made from biological materials as depicted in the Examples and the Figures, such composition providing for for allowing for the attachment of selenium to a surface.

“Mammal” for purposes of treatment refers to any animal classified as a mammal, including humans, domestic and farm animals, nonhuman primates, and zoo, sports, or pet animals, such as dogs, horses, cats, cows, etc.

The non-metal element “selenium” exists in several catalytic and non-catalytic oxidation states, in vitro and in vivo. If present in sufficient concentrations of thiol compounds, selenium compounds such as selenides, RSe-, oxidize thiols, producing superoxide (O₂⁻) and other biologically reactive oxygen species. Superoxide and the other produced reactive products, hydrogen peroxide, thiol radicals and other organic free radicals are toxic to biological membranes, molecules and cells. When present in sufficient concentration as the selenoselenide anion, RSe⁻, selenium can arrest and kill normal cells, cancer cells, bacterial cells, yeast cells and viruses. When organic selenium compounds are covalently attached to any targeting molecule such as a mono- or polyclonal antibody, peptide or polypeptide, hormone, vitamin, drug, or device, such conjugates comprise a new class of pharmaceuticals and devices that produce free radicals. Selenium is uniquely different from other elements that produce free radicals, i.e., iron, copper or cobalt, in that selenium can readily form small adducts replacing sulfur and it covalently combines with carbon and hydrogen compounds. Such selenium labeled adducts of the proper chemistry will remain non-toxic until activated by a thiol and the free radical pharmacology can be molecularly localized by the carrier molecule. This free radical chemistry is also useful for competitive protein binding assays. The free radical chemistry generated by selenium compounds can be detected by chemiluminescence or reduction of dyes, such as methylene blue, by a spectrophotometer providing for quantitation of a compound which binds the antibody, hapten or drug to which selenium is attached and to which it subsequently reacts with thiols.

“Biomolecules” such as antithrombogenics, antiplatelets, anti-inflammatories, antimicrobials, growth factors, proteins, peptides, and the like have been used to minimize adverse biomaterial-associated reactions. Biomolecules used according to this invention may be, for example, a globular protein, a structural protein, a membrane protein, a cell attachment protein, a protein, a structural peptide, a membrane peptide, a cell attachment peptide, a peptide, an anti-inflammatory agent, an antibody, an antigen, an immunoglobulin, a defense agent, a catalyst, an enzyme, a hormone, a growth factor, a neurotransmitter, a cytokine, a proteoglycan, a toxin, an antibiotic agent, an antibacterial agent, an antimicrobial agent, a regulatory agent, a transport agent, a fibrous agent, a blood agent, a clotting agent, a platelet agent, an antithrombotic agent, an anticoagulant agent, a polysaccharide, a carbohydrate, a fatty acid, a nucleic acid, a DNA segment, RNA segment, a lectin, a drug, a vitamin, a ligand and a dye (which acts as a biological ligand). The biomolecules may be found in nature (naturally occurring) or may be chemically synthesized.

A number of approaches have been suggested to attach such biomolecules. These approaches generally are covalent attachment techniques or ionic attachment techniques. Covalent attachment techniques typically require the use of coupling agents such as glutaraldehyde, cyanogen bromide, p-benzoquinone, succinic anhydrides, carbodiimides, diisocyanates, ethyl chloroformate, dipyridyl disulphide, epichlorohydrin, azides, among others, which serve as attachment vehicles for coupling of biomolecules to biomaterial surfaces. For example, covalent attachment of biomolecules using water soluble carbodiimides is described by Hoffman et al., “Covalent Binding of Biomolecules to Radiation-Grafted Hydrogels on Inert Polymer Surfaces,” Trans. Am. Soc. Artif. Intern. Organs, 18, 10-18 (1972); and Ito et al., “Materials for Enhancing Cell Adhesion by Immobilization of Cell-Adhesive Peptide,” J. of Biomed. Mat. Res., 25, 1325-1337 (1991).

Grafting of molecules such as monomers or polymers to biomaterial surfaces may be accomplished by a number of methods well known to those skilled in the art. For example, monomers or polymers comprising a vinyl reactive moiety may be grafted to biomaterial surfaces using various grafting methods including ceric ion initiation (CeIV), ozone exposure, corona discharge, UV irradiation or ionizing radiation (.sup.60 Co, X-rays, high energy electrons, plasma gas discharge).

In a preferred embodiment, Ti 6 A1-4V is made antimicrobial as shown by a CFU assay. While said embodiments disclose preferred methods for titanium or similar metals, the disclosed methods teach a conceptual approach through which other dissimilar materials such as organic polymers polyurethane, polyethylene, polycarbonate, and silicone polymers can be dipcoated.

In yet another embodiment, a selenium attachment agent comprises a functional end, A, for the attachment to a surface, incorporation into a polymer and/or used to derivatize a protein, polysaccharide, fatty acid or lipid and a selenium group covalently attached which is selected from the following: RSeH, RSeR′, RSeSeR′, and RSeX, wherein each of R and R′ comprise an aliphatic or ether residue terminated with alcohols, amines, carboxylic acids, silanes, phosponate, sulfonate or phenols for the incorporation into a polymer formulation, and wherein X is a protecting group selected from the group consisting of a halogen, an imide, a cyanide, an azide, a phosphate, a sulfate, a nitrate, a carbonate, selenium dioxide, and combinations thereof.

In yet another embodiment, the A group may be a group comprised of one or more of the following: vinyl, acrylate, methacrylate or silane.

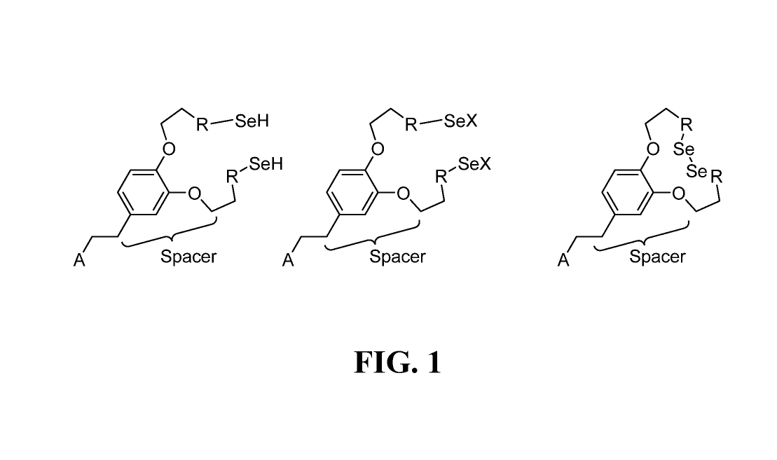

In yet another embodiment, the selenium attachment agent is comprised of a spacer possessing a rigid framework for a preorganized 3D motif for maximizing the spatial proximity of the selenium group and for close packing as on a surface (FIG. 1 and.

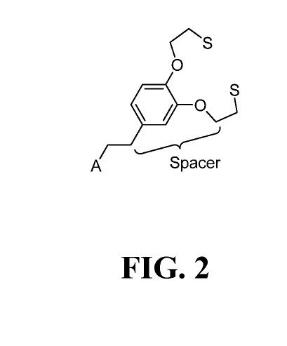

In yet another embodiment, the spacer is built from saffrole (FIG. 2).

In another embodiment the spacer is built from trimellitic anhydride and its derivatives.

In yet another embodiment, the organic selenium compound as set forth retains catalytic activity in the form of oxidative and reductive cycling to product super oxides which disrupts the life functioning processes of the microbes which come in contact with the surface which contains the organo-selenium compound attached to the substrate.

Another embodiment is a biocidal composition attached to a surface, comprising a selenium attachment agent, wherein said selenium attachment agent disrupts the life functioning processes of microbes to prevent biofilms, aid in the destruction of the microbe or produce toxic catalytic products such as super oxide that may accomplish, and combinations thereof.

In yet another embodiment, a selenium attachment agent comprises a multifunctional material with a selenium group for the promotion of the formation of superoxide, hydrogen peroxide or other toxic products, and/or the signaling of said process by the interaction of the reporter chromophore, and/or the inclusion of functional groups for the promotion or inhibition of growth of tissues. The selenium attachment agent may also work as a signaling agent for the function of the selenium group through incorporation of a reporter chromophore. Further the selenium attachment agent promotes the growth of tissue such as bone cells, skin cells or promotion of interaction with other biomaterial.

In another embodiment, coating formulation is introduced to the surface of titanium comprising a selenium attachment agent, wherein reactive anchor groups are coupled to surface activated atoms; said reactive anchor group are tethered to a biocidal group such as a selenium end group, or a function group capable of secondary reaction to said antimicrobial group. Another embodiment of this formulation includes a trialkoxy silane methacrylate or a trihalo silane methacrylate.

In yet another embodiment, a free radical reaction initiated by AIBN couples two methacrylate groups, wherein such coupling is initiated by carbon-carbon bond forming reactions, thus substituting to successfully join the anchor group with the antimicrobial group.

In yet another embodiment, the invention comprises a method for attaching a biocidal group to an anchor compound as a discrete free molecule, or attachment to the anchor group after the attachment to the surface of the titanium.

It is a further embodiment that an antimicrobial diselenide is prepared from the reaction product of disodium diselenide with reactive group characterized by one skilled in the art as a ‘good leaving group’ as a preferred embodiment tethered to a group capable of reacting with the anchor group.

It is yet another embodiment to prepare a series of diselenide or selenocyantates capable or being tethered to said anchor group, and possessing antimicrobial properties.

An anchor group comprising a dipodal reactive group such as a trialkoxy- or trihalo-silane attached to a dimethacrylate: preferably wherein the dipodal functional group allows for the proximal attachment of a symmetric diselenide dimethacarylate may also be achieved with this invention.

A preferred embodiment provides a method for functionalizing a surface such as Titanium 6A1-4V (medical grade) or similar grade titanium sheet that could be used for a functional devices, such as a fuel tank, for which having antimicrobial properties using methods for attachment, such as a dipcoat method. The dipcoat method may be further adapted to a spray based application system. The surface is selected from the group consisting of metal, tin-nickel alloys, shape memory alloys, aluminum oxide, platinum, platinum alloys, stainless steel, MP35N stainless steel, elgiloy, stellite, pyrolytic carbon, silver carbon, glassy carbon, polymer, polyamide, polycarbonate, polyether, polyester, polyolefin, polyethylene, polypropylene, polystyrene, polyurethane, polyvinyl chloride, polyvinylpyrrolidone, silicone elastomer, fluoropolymer, polyacrylate, polyisoprene, polytetrafluoroethylene, rubber, ceramic, hydroxapatite, human protein, human tissue, animal protein, animal tissue, bone, skin, teeth, collagen, laminin, elastin, fibrin, wood, cellulose, compressed carbon and glass, or solid substrates such as films, particularly polymeric films such as polysilicones, polyolefins, polyamides, and teflon.

In another embodiment, a method is presented for creating a redox—cycle facilitator atom or groups such as an adjacent hydroxyl group in proximity to the catalytic site of the diselenide. In a preferred embodiment, the facilitator group is a hydroxyl.

Yet another embodiment comprises a method for applying an adhesion facilitation group in close proximity to the antimicrobial groups that promotes adhesion of cells, including bone cells for the purposes of using titanium parts in repairing damage to bones in mammals.

In addition a method of applying differential coatings in close proximity such that more than one function could be achieved with said surface anchor group.

Further, it is yet another preferred embodiment that a composition comprising a three dimensional diselenide structure with antimicrobial properties is produced.

The following grafting examples provide composition and methods of how to attach layers or biomaterials to a surface or substrate.

### EXAMPLES

### Example 1

### Preparation of Deselenide Dimethacrylate

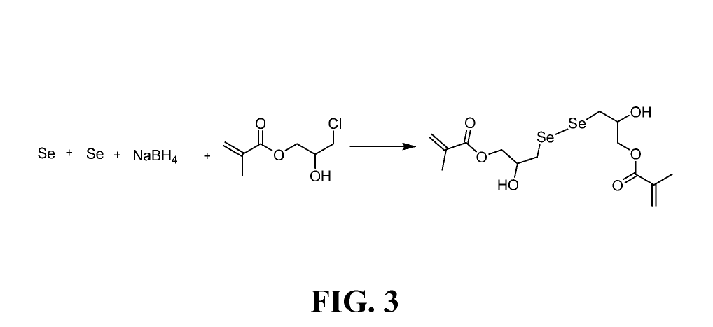

FIG. 3 represents this embodiment. Sodium borohydride (5.6 g, 148 mmol) and selenium (5.6 g, 70.9 mmol) were placed in an ice-cooled 3 necked flask fitted with a condenser, gas inlet adapter and dropping funnel under a nitrogen atmosphere. Water (300 ml) which had been purged for 30 minutes with nitrogen to remove any dissolved oxygen was added in a single portion. After the first addition for selenium and the solution had become clear and mostly colorless, the second portion of selenium (5.60 g, 70.9 mmol) was added. A heat gun was used to aid the dissolution of selenium as needed. The brownish-red solution of Na₂Se₂ was cooled to room temperature and the chloropropyl hydroxy methacrylate (12.67 g, 70.9 mmol) was added as a solution in ethanol. The reaction was stirred for an additional 3 hours, or until judged complete by TLC. Using TLC, the reaction was judged complete by elution with dichloromethane on silica gel, as it was obvious there was no starting material remaining.

The workup was accomplished by adding diethyl ether directly to the reaction mixture, decanting to a reparatory funnel and separating the organic phase. The aqueous reaction mixture was extracted three additional times with diethyl ether. The extracts were determined to be the same, and then were combined.

The ether was evaporated in vacuo.

When the extracts were analyzed by TLC and ethyl acetate was used as eluent, there was a single spot.

### Example 2

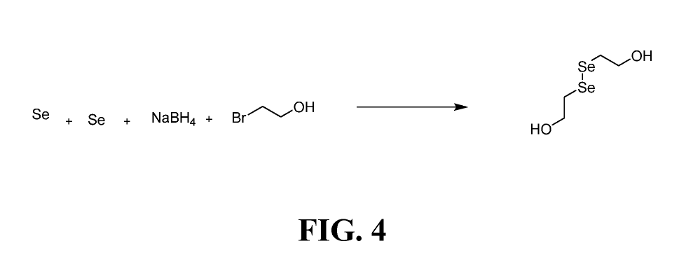

### Preparation of Deselenide Dialcohol as Monomer in Polymerization (FIG. 4)

In order to describe a crosslinker for plastic formation or copolymerization as described and claimed herein, sodium borohydride (7.55 g, 200 mmol) and selenium were placed in an ice-cooled 3 necked flask fitted with a condenser, gas inlet adapter and dropping funnel under a nitrogen atmosphere. Water (300 ml) which had been purged for 30 minutes with nitrogen to remove any dissolved oxygen was added in a single portion. After the first addition for selenium and the solution had become clear and mostly colorless the second portion of selenium (7.50 g, 95 mmol) was added. A heat gun was used to aid the dissolution of selenium as needed. The brownish-red solution of Na₂Se₂ was cooled to room temperature and the bromoethanol (14.18 ml, 190 mmol) was added as a solution in ethanol. The reaction was stirred for an addition 3 hours, or until judged complete by TLC. Using TLC, the reaction was judged complete by elution with dichloromethane on silica gel as it was obvious there was no starting material remaining.

The workup was accomplished by adding diethyl ether directly to the reaction mixture, decanting to a reparatory funnel and separating the organic phase. The aqueous reaction mixture was extracted three additional times with diethyl ether. The extracts were determined to be the same, and then were combined.

The ether was evaporated in vacuo. See FIG. 4 for this example.

### Example 3

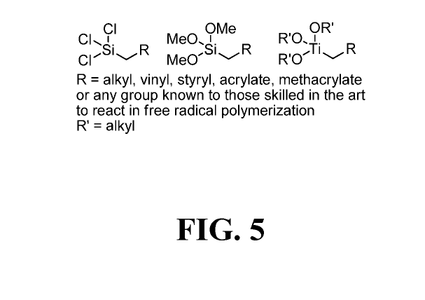

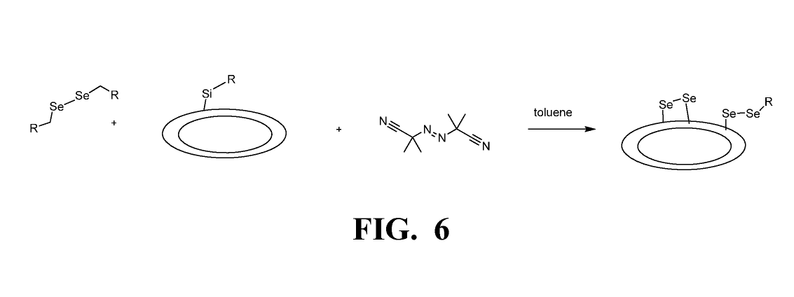

### General Method for Coating Titanium with Anchor Groups (FIG. 5 and FIG. 6)

The surface of the substrate, medical grade titanium 6A1-4V ELI, was treated with a 1:1 solution of 30% hydrogen peroxide in 98% sulfuric acid surrounded by an ice bath for 15 minutes. The titanium was triply washed with distilled water, dried in a 100 deg C. oven, and then placed in a solution of toluene. The surface activating agent were combined in toluene in a ratio of 10:1 alkyl to activated (vinyl, methacrylate, etc) to control the amount of Selenium compound that will be added in the next step. The ratio of hydrophobic groups to free radical activating groups may be varied to increase or decrease the surface activity of the selenium group. The ratio has been varied from 1:1 to 20:1, with a preferred ratio being 2.5:1 to 15:1. The titanium was then triply washed with toluene, then placed in a fresh solution of toluene. Qualitative attachment was observed by measuring the contact angle of water on the treated titanium.

| | Washer | Contact Angle | | | | |
|---|---|---|---|---|---|---|
| Sample | No treatment | 64.5 Straight A | 125 1A:1B | 122 2A:1B | 115 4A:1B | 121 |
| 1 | | 58 | 125 | 119 | 121 | 122 |
| 2 | | 58 | 118 | 115 | 113 | 114 |
| 3 | | 57 | 123.5 | 123 | 130 | 120 |
| 4 | na | | 110 | 110 | 122 | 110 |
| 5 | na | | 115 | 110 | 119 | 111 |
| 6 | na | | 115 | 112 | 111 | 112 |
| | na | | na | na | 115 | 121 |
| | AVG: | 59.375 AVG: | 118.7857 AVG: | 115.8571 AVG: | 118.25 AVG: | 116.375 |

### Example 4

### General Method for Attachment of Selenium Group to Anchor Via Free Radical Polymerization

The active selenium compound was added through free radical polymerization with AIBN (Azobisisobutyronitrile) as the activator in a ratio of 1.5 mg/mL heated to 90 deg C. The diselenide was added in a ratio of 1 mg/mL. The reaction was qualitatively followed by watching the disappearance of yellow color which ostensibly correlates to surface attachment. Upon completion, the titanium was washed with toluene.

### Example 5

### General Method for Copolymerizing Active Selenium Compounds Terminated with Diols or Other Reactive Groups

A polyurethane composition comprising a base formulation of oligomeric polyester terminated with alcohols or phenols with a molecular weight ranging from 1000-10000 amu with a preferred range of 1000-3000, an oligomeric triol composition with a molecular weight ranging from 1000-10000 amu with a preferred range of 1000-3000, a copolymer comprising a silicone, capable as acting as a surfactant, including catalysts or activators Sn(II) oleate and/or N-ethylmorpholine with an isocyante such toluene diisocyante or one or more of the following: diphenylmethane diisocyanate (MDI) or toluene diisocyanate (TDI); or aliphatic, such as hexamethylene diisocyanate (HDI) or isophorone diisocyanate (IPDI), and water.

While the example provides for the preparation of polyurethane, one skilled in the art would recognize that such condensation polymerizations would also be compatible with polyesters, polyamides, silicones, etc.

### Example 6

### A General Method for Attaching Diselenides to Silicone

To enable attachment to silicone, trichlorosilane anchor groups were attached to the surface of silicone, followed by free radical polymerization with an active selenide as described previously.

The active selenide compound was attached directly to the surface of silicone through free radical polymerization was described previously.

The surface of silicone was preactivated with an active oxidant such as dimethyl dioxirane, followed by anchor attachment with a silane, then free radical attachment.

### Example 7

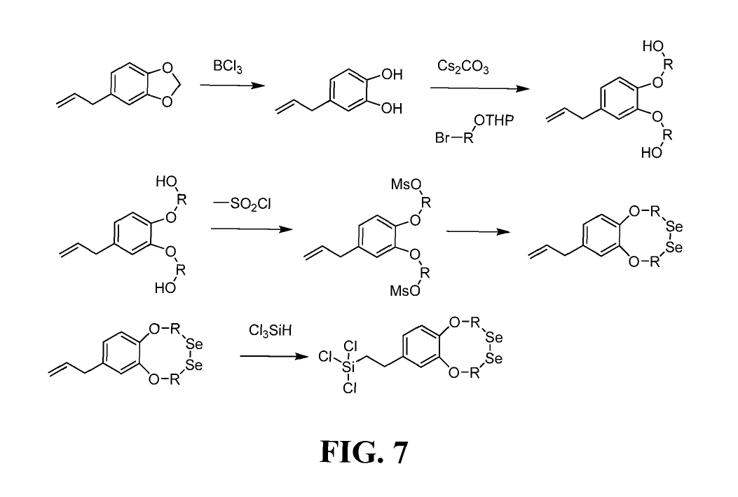

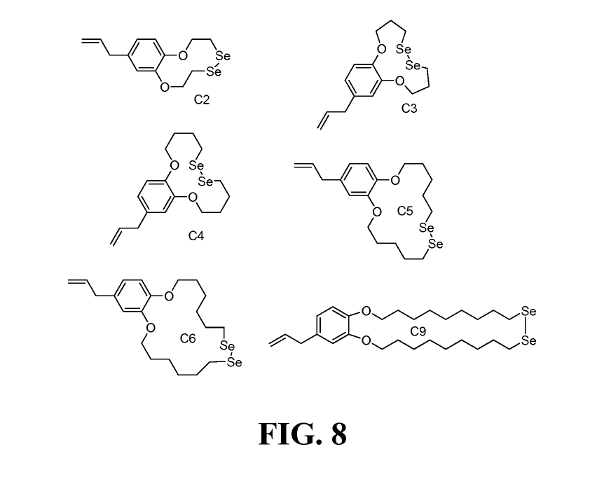

### Method for the Preparation of a Selenium Attachment Linker Comprising an Anchor Group and Selenide-Preferred Embodiment [FIG. 7 and FIG. 8].

### Example 8

### Titanium Attachment

In describing another embodiment for titatinum or other surface having metallic properties, a bromoalkyl trichlorosilane was similarly attached to the surface of titanium, leaving a silane anchor group with a terminal halide. Using substitution chemistry, KSeCN was reacted with the washer, resulting in a terminal SeCN group.

### Example 9

### A General Method for Preparing Diselenides Using Disodium Diselenide Under Aqueous Conditions

In order to show the preparation of selenium diselinides for use with the selenium attachment agent, sodium borohydride (7.55 g, 200 mmol) and selenium were placed in an ice-cooled 3 necked flask fitted with a condenser, gas inlet adapter and dropping funnel under a nitrogen atmosphere. Water (300 ml) which had been purged for 30 minutes with nitrogen to remove any dissolved oxygen was added in a single portion. After the first addition for selenium and the solution had become clear and mostly colorless the second portion of selenium (7.50 g, 95 mmol) was added. A heat gun was used to aid the dissolution of selenium as needed. The brownish-red solution of Na₂Se₂ was cooled to room temperature and the halogenated reactant was added.

### Example 10

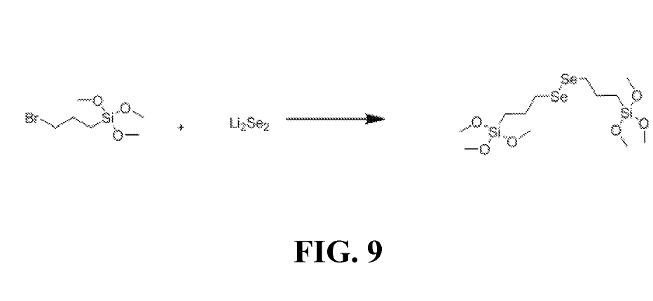

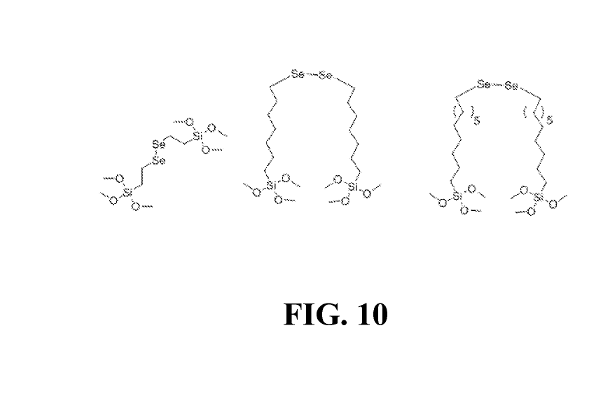

### A General Method for Preparing Diselenides Using Dilithium Diselenide Under Organic Conditions [See FIG. 9 and FIG. 10]

This example teaches the preparation of diselinides with water-sensitive functional groups, in the event solubility is not possible with halogenated reactant.

1:1 mole ratio solution was prepared by reacting elemental selenium with (1M) lithium triethyl borohydride in THF (Super Hydride™), then stirred for at least 30 minutes (FIG. 9). After the time elapsed, a solution of halogenated organic substrate was added in THF with tert-butanol as a coadditive. The reaction product was followed by TLC and stopped once the starting product was consumed. Other examples prepared using this method include those shown in FIG. 10.

### Example 11

### General Method for the Attachment of Trialkoxy Silanes to Activated Surfaces or Reactive Additives

In attaching selenium to surfaces such as glass, plastics, metals such as titanium, as well as biopolymers, these examples are preferred embodiments. Compositions of biopolymers comprised of polysaccharides, or synthetic polymers with alcohol functional groups react readily with trialkoxy silanes (3,3,12,12-tetramethoxy-2,13-dioxa-7,8-diselena-3,12-disilatetradecane, 1) to form covalent bonds. The reactivity is such that adding the trialkoxy silane, then stirring with dry powder compositions results in the substitution. In another embodiment, a diselenide terminated with a trimethoxysilane as attached to an activated titanium surface. In this example, the titanium surface was activated with 30% peroxide and hydrochloric acid solution, followed by rinsing with deionized water. When measured with a goniometer, the contact angle was less than 20. Upon exposure to a diselenide terminated with trimethoxy groups, the activated titanium surface became passivated, and showed antimicrobial activity.

### Example 12

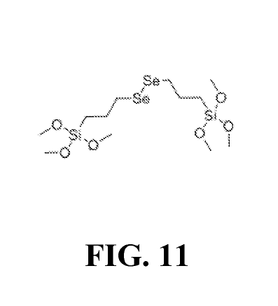

A General Method for Impregnating a Medical Grade Wound Dressing with a Medical Grade Polymer Made Antimicrobial from Covalent Attachment [FIG. 11]

In a exemplary example to show attachment to cellulose or other polymeric surface, see FIG. 11. 3,3,12,12-tetramethoxy-2,13-dioxa-7,8-diselena-3,12-disilatetradecane, 1, was stirred with hydroxyethyl cellulose. The product was filtered, rinsed with methanol, then dried. After the selenium labeled powder dried, it was dissolved in a reduced glutathione solution in phosphate buffered saline. Medical grade polyurethane foam was dipcoated and dried. When exposed to a chemiluminescent assay that detects superoxide generated from the redox cycling of Selenium, the foam generated photons greater than 100× a background composition.

### Example 13

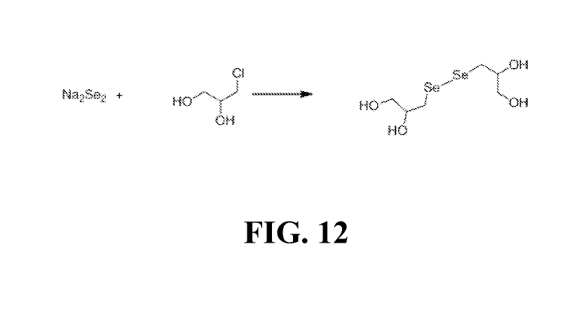

### Preparation of Deselenide Tetralcohol as Monomer in Polymerization [FIG. 12]

Using the general procedure in example 11, the diselenide, was prepared from 3-chloropropane-1,2-diol (FIG. 12). The product was used in condensation polymerization such as the preparation of polyurethane, foamed polyurethane and thermoplastic polyurethane.

### Example 14

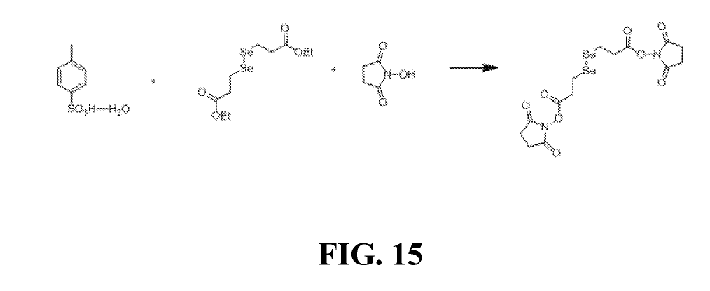

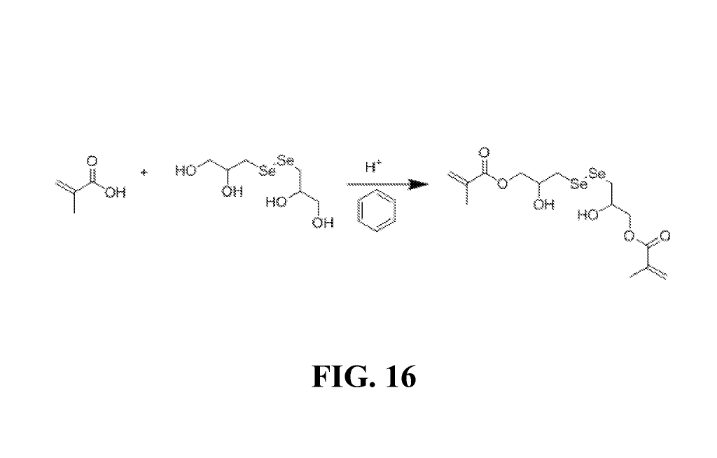

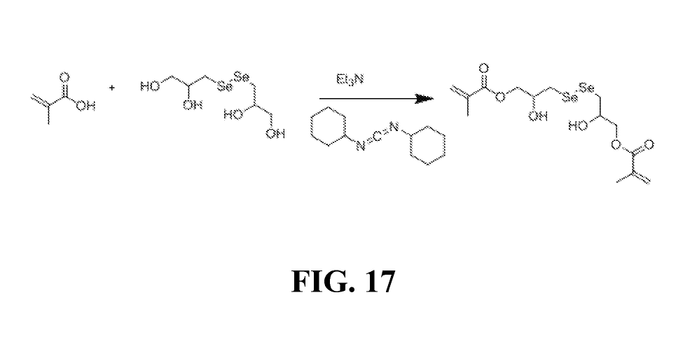

### Preparation of Deselenide Tetramine, (FIG. 15) or Activated Dicarboxylic Diselenide, (FIG. 16) as Monomer in Polymerization of for Conjugation to Proteins, Antibodies or Enzymes or Dimethacrylate, (FIG. 17)

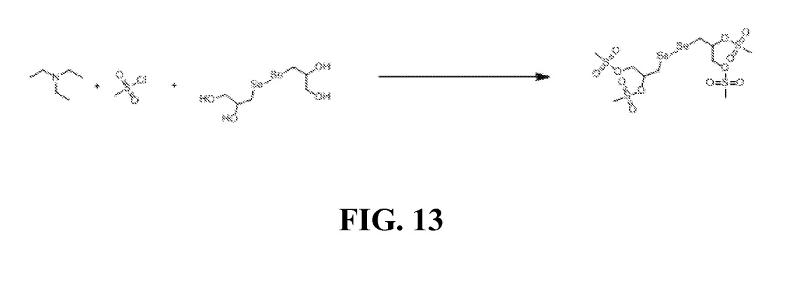

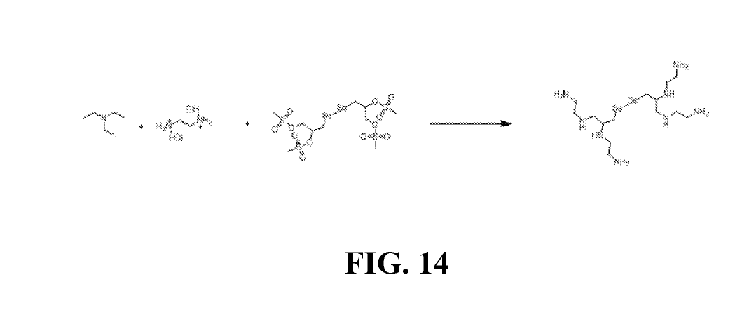

Diselenide (FIG. 14) can be functionalized through the reaction of FIG. 14 with methacrylic acid under dehydrating conditions. FIG. 13 further assists. One skilled in the art would recognize similar reactions would also be possible with acrylic acid. These reactions are examples, but not limiting in scope. Given the number of conversions possible with an alcohol functional group, the utility of the tetraol as an active or intermediate is self evident. The objective of this example is to provide for attachment of the selenium compound to proteins, enzymes and other biological structures.

### Example 15

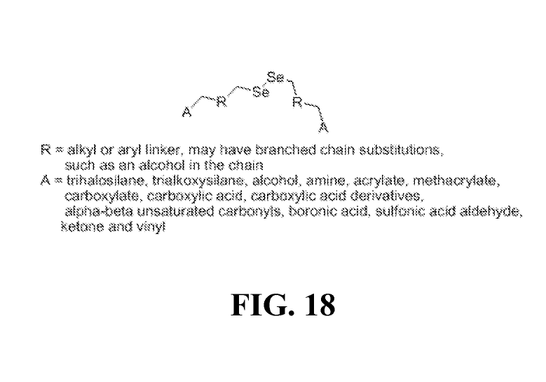

### Agent Structure. [FIG. 18]

FIG. 18 shows a preferred agent—the preferred chemical entity of the present invention.

1-23. (canceled)

24. A method for presenting a coating formulation to a surface, the coating formulation comprising selenium and a selenium attachment agent, the method comprising the steps of:
coupling at least one reactive anchor group to at least one activated atom present on the surface; and
tethering the at least one reactive anchor group to at least one biocidal group or a functional group capable of secondary reaction to the at least one biocidal group.

25. The method of claim 24, wherein the at least one biocidal group is a selenium end group.

26. The method of claim 25, wherein the selenium end group is a diselenide.

27. The method of claim 24, wherein the activated atom is selected from the group consisting of an acrylate, as methacrylate, a vinyl, an alcohol, an amine, a carboxylic acid, and combinations thereof.

28. The method of claim 27, wherein the anchor group and surface activated atom complex comprise at least one of a vinyl acrylate, a vinyl methacrylate, and combinations thereof.

29. The method of claim 28, wherein the anchor group and surface activated atom complex comprise at least one of a trialkoxy silane methacrylate, a trihalo silane methacrylate, and combinations thereof.

30. The method of claim 29, wherein a free radical reaction initiated by AIBN couples two methacrylate groups, and wherein the coupling step is initiated by carbon-carbon bond forming reactions whereby the at least one reactive anchor group is tethered to the at least one biocidal group.

31. The method of claim 24, wherein the activated atom comprises at least one of diphenylmethane diisocyanate (MDI), toluene diisocyanate (TDI), hexamethylene diisocyanate (HDI), isophorone diisocyanate (IPDI), and combinations thereof.

32. The method of claim 24, wherein the anchor group comprises a silane.

33. The method of claim 32, wherein the anchor group comprises trichloro silane.

34. The method of claim 24, wherein the surface comprises at least one of polyurethane and silicone.

35. An anchor group comprising a dipodal reactive group attached to a dimethacrylate.

36. The anchor group of claim 35, wherein the dipodal reactive group is at least one of a trialkoxy silane, a trihalo silane, and combinations thereof.

37. The anchor group of claim 35, wherein the dipodal reactive group allows for the proximal attachment of a symmetric diselenide dimethacarylate.

38. A selenium attachment agent comprised of a spacer possessing a rigid framework for a preorganized 3D motif for maximizing the spatial proximity of a selenium group and for close packing on a surface, the selenium attachment agent comprising at least one of the following structures: 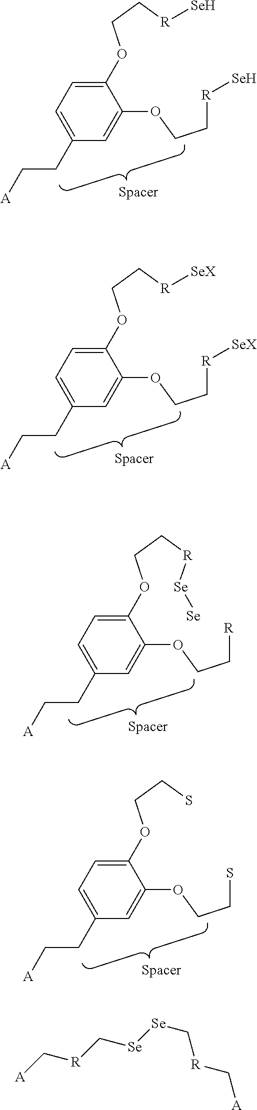
wherein A is at least one of vinyl, acrylate, methacrylate, silane, and combinations thereof;
wherein R is an alkyl or aryl linker;
wherein R′ comprises an aliphatic or ether residue terminated with alcohols, amines, carboxylic acids, silanes, phosponate, sulfonate or phenols; and
wherein X is a protecting group selected from the group consisting of a halogen, an imide, a cyanide, an azide, a phosphate, a sulfate, a nitrate, a carbonate, selenium dioxide, and combinations thereof.

39. The selenium attachment agent of claim 38, wherein R has at least one branched chain substitution.

40. The selenium attachment agent of claim 39, wherein the selenium retains oxidative properties.

41. A method, comprising:
creating a redox—cycle facilitator atom or group in proximity to a catalytic site of a diselenide.

42. The method of claim 41, wherein the redox—cycle facilitator group comprises an adjacent hydroxyl group.

43. The method of claim 41, wherein the redox—cycle facilitator group is a hydroxyl.

44. The method of claim 41, further defined as applying an adhesion redox—cycle facilitator group in close proximity to the catalytic site of the diselenide, wherein the diselenide is an antimicrobial group that promotes adhesion of cells.

45. The method of claim 41, further defined as applying differential redox—cycle facilitator atoms or groups in close proximity to the catalytic site of the diselenide, whereby more than one function is achieved with a selenium attachment agent.
